(19) United States
(12) Patent Application Publication
(10) Pub. No.: US 2006/0216388 A1
(43) Pub. Date: Sep. 28, 2006

(54) Bread compositions containing sugar beet pectins

(76) Inventor: Jan Aa Staunstrup Christensen, Bonshoj (DK)

Correspondence Address: David M. Goodrich, Esq.;J. M. Huber Corporation, 333 Thornall Street, Edison, NJ, 08837-2220, US

(21) Appl. No.: 11/378,035

(22) Filed: Mar. 17, 2006

Related U.S. Application Data
(60) Provisional application No. 60/665,661, filed on Mar. 28, 2005.

(51) Int. Cl. A21D 10/00

(52) U.S. Cl. 426/549

(57) ABSTRACT

Disclosed is a food composition comprising: water, salt, yeast, wheat flour, and sugar beet pectin.

### BACKGROUND OF THE INVENTION

Bread is one of the most widely consumed foods in the world today, enjoyed throughout the world by peoples of nearly all cultures and backgrounds. Bread has been consumed by humans since at least the stone age, and was subjected to extensive early development so that bread as we know it today is composed of the same four basic ingredients as it has been for thousands of years: flour, water, salt, and yeast.

In recent years, bread science has progressed rapidly so that bread making and bread formulation have become increasingly more sophisticated. In particular, a broad array of new bread additives have been developed to enhance the quality of bread, especially bread produced on commercial scales. For example, an enzyme is a type of bread additive that serves as a processing aid during the early stages of mixing, processing and baking of bread, but which also exist in heat-stable forms like the amylases which improve product texture and softness. Other enzymes perform equally important roles, like delaying the onset of staleness in the bread and thereby extending the bread's shelf life. Enzymes and other additives included in bread recipes and formulas provide significant benefits to both bread manufactures and consumers. For bread manufacturers, these additives assist in the processing and manufacturing of bread while at the same time increasing baked bread volume. For consumers, the result of these additives is a much enhanced bread product that has better crumb softness and has a mouth feel and texture like that of fat.

Polysaccharides are particular bread additives that have long been used in many different food products, not only bread but also beverages and beverage additives, jams, jellies, preserves and other food products. Polysaccharides provide important food additive functions like controlling texture, mouth feel, and rheology. Notable polysaccharides include carrageenan, xanthan gum, gellan gum, gum Arabic, and pectin. Pectins are particularly important polysaccharides, especially high-ester pectins (or HM-pectins), which have at least 50% of their carboxyl groups methylated and are most commonly extracted from citrus peels. HM-pectins have been used in breads where they can provide a remarkably broad set of benefits, such as binding and adsorption of free water, increasing bread volume, and giving the bread an attractive and appetizing soft texture. Additionally, these HM-pectins increase the amount of air that is entrapped in the bread; the greater amount of entrapped air and the increased number of air bubbles in the bread results in bread that has a longer shelf life and has improved crumb softness and texture.

While these conventional HM-pectins are particularly effective and beneficial as bread additives, their importance in bread recipes and formulas is such that additional performance improvements would be highly beneficial both to bread manufacturers (for whom greater volume and ease of processibility would make bread products more profitable) as well as consumers (who would enjoy longer lasting bread with a more pleasing texture). Accordingly, there is a continuing need in the art for improved pectins.

### BRIEF SUMMARY OF THE INVENTION

The present invention includes a food composition containing water, salt, yeast, wheat flour, and sugar beet pectin.

The present invention also includes a method for forming ferulic acid crosslinks including the steps of: providing a source of ferulic acid; providing a wheat flour source comprising gluten; mixing together the source of ferulic acid and the wheat flour source to form a dough; and baking the dough whereby ferulic acid crosslinks are formed between the source of ferulic acid and the gluten.

### DETAILED DESCRIPTION OF THE INVENTION

All parts, percentages and ratios used herein are expressed by weight unless otherwise specified. All documents cited herein are incorporated by reference.

The present invention is directed towards a bread composition containing sugar beet pectin for use in bread compositions. When included in a bread composition along with other basic bread ingredients such as wheat flour, salt, water and yeast, as well as modem bread additives, the result is a bread product that has an increased volume, is softer and has a better texture, and stays fresh longer. This sugar beet pectin will be described in greater detail and then next will be placed in the context of the overall recipe for bread products.

The Sugar Beet Pectin Polysaccharide

The sugar beet pectin extracted from spent sugar beet pulp (or fibers), which is a by-product of sugar beet refining. After refining, the sugar beet pulp starting material may optionally be washed or dried or subjected to a combination of both washing and drying before being shipped to an off-site plant for the extraction of its remaining pectin material. Regardless of which of these options is utilized, pectin is prepared from the sugar beet pulp in a conventional fashion by the three step process of liquid extraction of the pectin from the sugar beet pulp (typically at acidic pH), purification of the liquid sugar beet extract, and isolation of the extracted pectin from the liquid extract. The practice, operation, and maintenance of such pectin-winning and refining processes are well known to those of ordinary skill in the art.

The bread products of the present invention containing sugar beet pectin, have a measurably increased baked bread volume, softer texture and better anti-staling performance as compared to bread products containing pectins made from citrus plant starting material. An important characteristic of sugar beet pectin that may explain this improved performance is that sugar beet pectin contains ferulic acid, which is not found in pectin extracted from citrus pulp or fibers. Sugar beet pectin contains about 0.6 wt % to about 3 wt % of ferulic acid. The effect of ferulic acid is discussed in greater detail below.

The bread compositions of the present invention comprise about 0.03 wt % to about 1.2 wt %, preferably about 0.05 wt % to about 0.65 wt % of sugar beet pectin. In use, pectin is added to a bread composition, which includes the four basic ingredients of wheat flour, water, salt, and yeast.

The Basic Four Bread Ingredients

Wheat flour is the main ingredient in bread. Wheat flour is the final product of the complicated milling process that begins with wheat cereal grains. Wheat flour is itself comprised of mostly starch (about 70 wt %) and proteins (about 6-18 wt %), with the balance being lipids (which come mostly from the wheat germ) and “non-starch” polysaccharides, which make up the cell walls in the endosperm of the wheat, this is also commonly referred to as “fiber”.

Typically protein is the most important part of the wheat flour, as the amount of protein in the wheat flour often determines the product being made. For example, cookies, cakes, and sweet rolls are generally made from wheat flour that has the lowest protein content, while bread and paste is typically made from wheat flour that has the greatest protein content. Although certain variations in the protein content of the wheat flour are found, for example in Japan sweet rolls are made from flours with the highest protein content (e.g., 11.5%-13.5%). Generally the protein content of wheat flour is proportional to the hardness of the wheat from which it is milled. While the protein itself can be broken down in to further constituents, the most pertinent part of the protein is the water-insoluble gluten protein (commonly referred to as “wheat gluten” or simply “gluten”).

These glutens form a network structure with the aforementioned non-starch polysaccharide. The part of the non-starch polysaccharide that is not cellulose is referred to as hemicellulose. The fractions of the hemicellulose where the main chain is made up of five carbon sugars are referred to as “pentosans”. The network structure is formed when these wheat flour pentosans bond with glutens by the action of ferulic acid groups, which act as cross links between the pentosans and the glutens.

While not intending to be limited by theory it is believed that in the present invention additional network bonding occurs, specifically, additional bonding of sugar beet pectin molecules to gluten, by the ferulic acid groups extending from the sugar beet pectin molecules. This additional bonding is responsible for the improved performance that results from the inclusion of sugar beet pectin because in addition to the pentosan being bonded to the gluten (by ferulic acid crosslinks) the gluten is also bonded to the sugar beet pectin (again by ferulic acid crosslinks). This results in a more highly networked dough structure offering increased baked bread volume and softness, among other benefits.

Because the sugar beet pectin bonds with the gluten (possibly in the manner described immediately above) to increase and enhance the gluten network, the sugar beet as used in the bread compositions of the present invention is a more effective booster of bread volume than other pectin materials. Accordingly, in bread compositions prepared according to the present invention less sugar beet pectin may be used in comparison to the pectin concentration of prior art bread materials, while obtaining the greater, or at least, comparable bread volume increases. Thus, the bread compositions of the present invention use less pectin, and yet have the same or comparable bread volume in comparison to prior art pectin containing bread compositions.

In addition to wheat flour, bread compositions also include yeast which make possible the fermentation process by which carbohydrates are converted into carbon dioxide and ethanol. The resulting fermentation gases provide the lift that produces a light or leavened loaf of bread. The two remaining essential ingredients of bread are salt and water. Salt is used as low levels of 1-2 wt % to improve taste and affect the mixing doughs' rheological properties, while water forms the balance of the bread recipe and acts as a plasticizer, solvent, and reaction medium.

Additional Bread Additives

In addition to the aforementioned ingredients, bread may also contain several other ingredients such as fat, sugar, enzymes, oxidants, surfactants, fortifying nutrients, and other assorted ingredients. These ingredients shall now be described in greater detail.

Fat (also in the form of shortening) may be added to the bread. In the dough mixing stage, fat acts as a plasticizer and a volume increaser—potentially increasing baked bread volume by as much as 10%. Fat also provides anti-staling benefits, making for a longer lasting bread.

Sugar may be added to a bread formula and acts as a carbohydrate source during fermentation and additionally provides a slightly sweet taste to bread, typically bread for the U.S. market. When sugar is present, the amount added will be from about 1 wt % to about 35 wt %, more preferably from about 1 wt % to about 25 wt %.

Enzymes are perhaps the most important of these optional additives. Of these the most important is α-amylase enzyme, which is added primarily to soften the bread and give it a better texture and mouth feel, and also may be added for anti-staling benefits. Suitable commercial forms of enzymes include the Bakezyme Go 1500® glucose oxidase enzyme from DSM Bakery Ingredients, Delft, Holland and the Bakezyme HE-1000® enzyme blend of cellulase and hemicellulase enzymes, also available from DSM Bakery Ingredients. Suitable commercial forms of α-amylase enzyme is available under the MaxLife E5™ brand from Danisco ApS, Copenhagen, Denmark, as well as the Fungamyl® amylase enzyme from Novozymes ApS, Bagsvaerd, Denmark. A suitable xylanase is Pentopan® 500 also available from Novozymes ApS. A suitable γ-enzyme is available under the brand SoftMax™ from Amano Enzymes, Inc., Nagoya, Japan.

Enzymes may also be added to bread recipes, to affect dough behavior during mixing and baking.

If desired, enzymes may be blended or admixed with other ingredients and added to the bread recipe as a single ingredient. For example, FREEZE-J (available from CP Kelco, ApS, Lille Skensved, Denmark) is a mixture of citrus-extracted pectin with about 1 wt % enzymes. Such a pectin-enzyme admixture should comprise about 51 wt % to about 99 wt %, preferably about 55 wt % to about 70 wt % pectin, and about 0.02 wt % to about 1 wt % of enzymes—dependent upon specific enzyme activity—where the basis weight is the total weight of the admixture.

Oxidants are added to bread formulations at low levels (measured in ppm) to improve dough strength during the various stages of processing (mixing, fermentation etc.) and to produce a bread with desirable attributes such as improved volume and texture. A non-exclusive list of oxidants includes compounds such as ascorbic acid (most notably), as well as potassium bromate, azodicarbonamide, and calcium peroxide.

Surfactants may also be included to function as dough strengtheners, emulsifiers, and anti-staling agents. Preferred surfactants include sodium stearoyl lactylate, ethoxylated monoglycerides, and diacetyl tartaric acid esters of monoglycerides and diglycerides (DATEM). A particularly preferred DATEM is the DW 8000 DATEM sold by the Griinau GmbH, of Illertissen, Germany.

An array of nutritional enrichment additives may also be added to bread, and indeed for at least the last fifty years the nutritional content of the flour has been enriched at least in part to replace the nutritional material lost during the milling process. Today these nutritional enrichment additives include vitamins, dietary fibers, and other nutritional supplements such as thiamin, riboflavin, folic acid, and iron, among others. Flavorings and other texture and sensory-affecting additives may also be included, such as eggs, honey, syrups, fruits, nuts, and spices.

The invention will now be described in more detail with respect to the following, specific, non-limiting examples.

### EXAMPLES

Sandwich-type bread samples were prepared according to the present invention and to the prior art as follows. First, ascorbic acid was mixed with water and then yeast and oil added to the mixture. Next, flour, emulsifier, and pectin were introduced into the mixture using, for example, a Diosna spiral mixer to form the dough. (The exact mixing time was determined by a faminograph measurement of the flour.) The dough was then scaled into 600 gram pieces and the dough was allowed to rest for 10 minutes. Each of the pieces was then formed into loads and placed in a greased pan. (Proofing conditions were temperature of 37° C., relative humidity of 70%, and time of 60 minutes.) Baking took place in a ventilated oven at a temperature of 180° C. for 28 minutes with 20 seconds initial addition of steam.

The ingredients and ingredient concentration used in the recipes are given in the Tables below. Each recipe is almost identical except for the amount of pectin used and the presence or non-presence of enzymes. Examples 1-4 contain no enzymes. Examples 5-8 do contain enzymes. Pectin was used at a standard ratio of 1.05% of the weight of flour (so that pectin was at a concentration of 0.59 wt % of the entire recipe) for compositions 3, 4, 7, and 8. While pectin was used at a reduced ratio of 0.63% of the weight of flour (so that pectin was at a concentration of 0.35 wt % of the entire recipe) for compositions 2 and 6. In summary, compositions 1, 4, 5, and 8 represent the prior art, while compositions 2, 3, 6, and 7 represent the present invention.

TABLE I
Bread Composition Number

| | 1 | 2 | 3 | 4 | 5 | 6 | 7 | 8 |
|---|---|---|---|---|---|---|---|---|
| Wheat Flour | 56.2 | 56.4 | 56.2 | 56.2 | 56.2 | 56.4 | 56.2 | 56.2 |
| Sugar | 1.2 | 1.1 | 1.2 | 1.2 | 1.2 | 1.1 | 1.2 | 1.2 |
| Salt | 0.9 | 0.8 | 0.9 | 0.9 | 0.9 | 0.8 | 0.9 | 0.9 |
| Compressed | 2.9 | 2.9 | 2.9 | 2.9 | 2.9 | 2.9 | 2.9 | 2.9 |
| Yeast | | | | | | | | |
| DATEM | 0.2 | 0.2 | 0.2 | 0.2 | 0.2 | 0.2 | 0.2 | 0.2 |
| (DW-8000) | | | | | | | | |
| Pectin* | 0.0 | 0.35 | 0.59 | 0.59 | 0.0 | 0.35 | 0.59 | 0.59 |
| | | (Pectin 1) | (Pectin 1) | (Pectin 3) | | (Pectin 2) | (Pectin 2) | (Pectin 4) |
| Shortening | 2.9 | 2.8 | | 2.9 | 2.9 | 2.8 | 2.9 | 2.9 |
| Enzyme | — | — | — | — | 1.0 | 1.0 | 1.0 | 1.0 |
| Water | 34.5 | 34.5 | | 34.5 | 34.5 | 34.9 | 34.5 | 34.5 |

(Composition figures do not add up to exactly 100% because of rounding error. The two significant figures were retained for concentration of pectin only.)

The pectins used in the bread composition above, were as follows:

TABLE II

| | Composition |
|---|---|
| Pectin 1 | Sugar Beet Pectin according to the Present |
| | Invention |
| Pectin 2 | Sugar Beet Pectin according to the Present |
| | Invention blended with 1% enzyme |
| Pectin 3 | Conventional Prior Art HM-pectin |
| Pectin 4 | Conventional Prior Art HM-pectin blended |
| | with 1% enzyme |

(Notes to Table II: Pectins 1-4 are all blended with sugar for standardization purposes the amount of pectin listed in Table I, is the actual amount of pectin used and does not include the weight of the sugar. Additionally, Pectins 2 and 4 were blended with about 1 wt % enzyme as described in Table II. This enzyme amount is listed in Table I, above.)

Each of these bread samples were then tested and measured. The volume of each bread sample was measured using a volumeter.

The bread was sliced into 25 mm thick slices, and a circular piece was cut out of the middle. The softness of the circular-shaped pieces were then analyzed by the use of the TA-XT2 texture analyzer available from Stable Micro Systems, Godalming, Surrey, United Kingdom.

The softness of the bread was the force used to compress the bread by 25% or 6.25 mm. The results from these tests and measurements are set forth in table III, below. Additionally, the volume and softness measurements can be integrated into a single parameter that is inclusive of the performance of the pectin in affecting both the volume and softness values. This volume to softness ratio is as follows:

$$Ratio = \frac{volume}{softness}$$

In this ratio, the better performing bread based on volume and softness, would have the higher ratio.

TABLE III
Results of measurement and Testing

| | | | | | | | | | % |
|---|---|---|---|---|---|---|---|---|---|
| | | | Pectin | | | 2 day | | % Volume | Softness |
| No. | Pectin Type | Status | Concentration | Enzyme | Volume | Softness | Ratio | Increase | Improvement |
| 1 | None | Prior art | 0 | N | 5.35 | 171 | 0.031287 | — | — |
| 2 | Pectin 1 | Present | 0.35 | N | 5.68 | 110 | 0.051636 | 6.2 | 36 |
| | | Invention | | | | | | | |
| 3 | Pectin 1 | Present | 0.59 | N | 5.82 | 122 | 0.047705 | 8.8 | 29 |
| | | Invention | | | | | | | |
| 4 | BIG | Prior Art | 0.59 | N | 5.64 | 132 | 0.042727 | 5.4 | 23 |
| 5 | None | Prior art | 0 | Y | 5.8 | 112 | 0.051786 | — | — |
| 6 | Pectin 1 | Present | 0.35 | Y | 6.21 | 89 | 0.069775 | 7.1 | 21 |
| | | Invention | | | | | | | |
| 7 | Pectin 1 | Present | 0.59 | Y | 6.35 | 95 | 0.066842 | 9.5 | 15 |
| | | Invention | | | | | | | |
| 8 | FREEZE | Prior Art | 0.59 | Y | 6.23 | 106 | 0.058774 | 7.4 | 5 |

Two sets of compositions were prepared, these sets being distinguished by whether they contained enzyme or not. Compositions 1-4 contained no enzyme, and Composition 1, which contained neither enzyme nor pectin served as the reference composition. Compositions 5-8 did contain enzyme, and composition 5, which did not contain pectin served as the reference composition.

As can be seen from the table above, when an equal amount of sugar beet pectin of the present invention (viz., Pectins 1 and 2) and pectin as known in the prior art (viz., Pectins 3 and 4) are used, the bread containing sugar beet pectin according to the present invention had a greater volume increase compared to the volume increase of the prior art bread composition (using the reference bread sample as the basis for measuring the volume increase). Compare the volume increase of composition No. 3 with No. 4 and Composition No. 7 with No. 8.

Additionally, it should be noted that comparable increases in bread volume to that volume obtained with prior art pectin were obtained with a bread composition containing pectin according to the present invention even when using a smaller amount of pectin. For example, bread composition no. 2 (which was prepared according to the present invention) contained only 0.35 wt % pectin and yet had a 6.2% volume increase over the prior art, while bread composition no. 4 (which was prepared according to the prior art) had more pectin, 0.59%, but showed a smaller volume increase, 5.4%. Similarly, bread composition no. 6 (which was prepared according to the present invention) contained only 0.35 wt % pectin and yet had a 7.1% volume increase over the prior art, while bread composition no. 8 (which was prepared according to the prior art) had more pectin, 0.59%, but showed only a slightly greater volume increase, 7.4%.

Thus, in bread compositions containing sugar beet pectin according to the present invention, the amount of pectin is reduced compared to prior art pectin-containing bread compositions, and yet at the same time the bread compositions of the present invention have comparable or superior bread volume compared to the prior art bread compositions. A person of ordinary skill in the art would not have expected such significantly improved results.

Similarly, as can be seen in Table III, the softness of the bread is also enhanced significantly in bread compositions containing sugar beet pectin according to the present invention. Indeed, this was the case for every bread composition containing sugar beet pectin according to the present invention. Bread compositions 2, and 3 were each softer than bread composition 4 (the lower number indicating the softer bread) on both day 1 and day 2 when compared to the bread compositions of the prior art. Similarly bread compositions 6, and 7 were each softer than bread composition 8 on both day 1 and day 2 when compared to the bread compositions of the prior art. A person of ordinary skill in the art would not have expected such significantly improved softness results.

The overall improvement in both softness and volume can be better assessed by integrating measurements of both values into a single parameter, viz., the volume to softness ratio mentioned above. As can be seen in Table III, the bread compositions containing pectin according to the present invention outperformed the bread compositions containing pectin according to the prior art, even when using a smaller amount of pectin. Bread composition nos. 2 and 3 both had higher ratio values than composition no. 4. Likewise, both composition nos. 6 and 7 had higher ratio values than composition no. 8. Bread compositions containing pectin according to the present invention and also containing enzyme, preferably have a ratio value of greater than 0.060, preferably greater than 0.065.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A food composition comprising:
water,
salt,
yeast,
wheat flour, and
sugar beet pectin.

2. The food composition according to claim 1, wherein the sugar beet pectin contains about 0.6 wt % to about 3.0 wt % of ferulic acid.

3. The food composition according to claim 1, wherein the sugar beet pectin is present at a concentration of from about 0.05 wt % to about 1.2 wt %, preferably from about 0.3 wt % to about 0.65 wt %.

4. The food composition according to claim 3, further comprising one or more enzymes.

5. The food composition according to claim 1, further comprising an additive selected from the group comprising fat, sugar, enzymes, oxidants, surfactants, and fortifying nutrients.

6. A method for forming ferulic acid crosslinks comprising the steps of:
providing a source of ferulic acid;
providing a wheat flour source containing gluten;
mixing together the source of ferulic acid and the wheat flour source to form a dough; and
baking the dough whereby ferulic acid crosslinks are formed between the gluten and the source of ferulic acid.

7. The method for forming ferulic acid crosslinks according to claim 6, wherein the source of ferulic acid is sugar beet pectin.

8. The food composition according to claim 3, wherein the volume to softness ratio is greater than about 0.06, preferably greater than about 0.065.

9. The food composition according to claim 1, further comprising from about 1 wt % to about 35 wt % sugar.

10. A food composition comprising:
water,
salt,
yeast,
wheat flour, and
about 0.05 wt % to about 1.2 wt %, preferably from about 0.3 wt % to about 0.65 wt % sugar beet pectin.
